(19) United States
(12) Patent Application Publication
(10) Pub. No.: US 2016/0335581 A1
(43) Pub. Date: Nov. 17, 2016

(54) SYSTEMS, DEVICES, AND METHODS FOR CONTROLLING AN ELECTRONIC DISPLAY DEVICE TO RENDER A GRAPHICAL USER INTERFACE WITH SELECTIVELY OBFUSCATED PORTIONS TO PROTECT CONFIDENTIAL OR PRIVATE INFORMATION

(71) Applicant: Wal-Mart Stores, Inc., Bentonville, AR (US)

(72) Inventors: Nicholaus Adam Jones, Fayetteville, AR (US); Matthew Allen Jones, Bentonville, AR (US); Robert James Taylor, Rogers, AR (US)

(21) Appl. No.: 15/154,424

(22) Filed: May 13, 2016

Related U.S. Application Data
(60) Provisional application No. 62/162,315, filed on May 15, 2015.

(51) Int. Cl. G06Q 10/06; G06F 3/0481; G06F 3/0484; G06F 21/62

(52) U.S. Cl. CPC G06Q 10/06398; G06F 21/6245; G06F 3/0481; G06F 3/0484

(57) ABSTRACT

Provided herein are methodologies, systems, apparatus, and non-transitory computer-readable media for configuring a graphical user interface of an electronic display device for selectively displaying or obfuscating individual performance data. Activity data relating to one or more individuals may be collected and used to compute a performance metric associated with the individual's employment activities. In a first mode of operation a GUI of an electronic display device displays a graphical indication of the performance metric. Once identification information is received relating to a specific individual, the GUI may operate according to a second mode of operation, which displays specific information relating to that individual and obfuscates that specific information such that only the individual accessing the GUI can read or decipher the specific information.

### RELATED APPLICATIONS

This application claims priority to U.S. Provisional Patent Application Ser. No. 62/162,315 entitled “SYSTEMS, DEVICES, AND METHODS FOR CONTROLLING AN ELECTRONIC DISPLAY DEVICE TO RENDER A GRAPHICAL USER INTERFACE WITH SELECTIVELY OBFUSCATED PORTIONS,” filed on May 15, 2015, the content of which is hereby incorporated by reference in its entirety.

### BACKGROUND OF THE TECHNOLOGY

In general, workers within an enterprise may be graded and evaluated based on various activity and/or performance metrics. Certain existing performance monitoring techniques allow managers to track certain activities associated with a particular worker or associate and reward exceptional performance.

### SUMMARY

In accordance with exemplary embodiments, a method of controlling an electronic display device in response to instructions from a server via a communication network to render a graphical user interface on the electronic display device with portions of the display being obfuscated to protect private or confidential information associated with a user of the electronic display device and rendered in the graphical user interface is disclosed. The method includes receiving, in an electronic computer-readable format, activity data by an electronic device in a retail store, the activity data being received from one or more databases and relating to one or more employment activities performed by an individual in the retail store, the activity data including an indication of a status of completion of the one or more employment activities by the individual. The method also includes computing a performance metric associated with the individual by the electronic device, the performance metric being quantified based on predefined measures of a net value associated with a performance of the individual with respect to the one or more employment activities. The method also includes operating the electronic device according to a first mode of operation to render a graphical user interface on an electronic display device via the electronic device, the graphical user interface including a decipherable graphical indication of the performance metric. The method also includes receiving, via a user-machine interface, identification information relating to the individual. The method also includes operating the electronic device according to a second mode of operation to update the graphical user interface, in response to the identification information, to display specific information relating to the individual. The method also includes obfuscating a portion of the graphical user interface corresponding to the specific information relating to the individual to render the specific information undecipherable to others while allowing the individual accessing the graphical user interface decipher the specific information, wherein a remainder of the graphical user interface is decipherable by others.

In some embodiments, the performance metric includes a real money value reported resulting from the one or more employment activities performed by the individual. In some embodiments, the performance metric includes an increase in a customer satisfaction rating resulting from the one or more employment activities performed by the individual. In some embodiments, receiving identification information includes receiving information from the individual via a magnetic strip reader, an RFID reader, a keyboard, or a biometric reader. In some embodiments, the performance metric includes a ranking of the individual's performance compared to other individuals working within a single store. In some embodiments, performing a task at an improper time negatively effects the performance metric associated with the individual. In some embodiments, the graphical user interface is further configured to receive an audit request initiated by a second individual requesting an audit of the status of completion of the one or more employment activities. In some embodiments, the activity data is input manually by the individual's manager or supervisor. In some embodiments, the graphical user interface further includes a graphical indication of an achievement earned by the individual in response to performing one or more specific tasks. In some embodiments, the graphical user interface is programmed to update in real-time to indicate a modification of the decipherable graphical indication of the performance metric, based on the activity data indicating completion of the one or more employment activities.

In accordance with exemplary embodiments, a system for obfuscating private or confidential information associated with a user is disclosed. The system includes one or more servers programmed to receive, in an electronic computer-readable format, activity data by an electronic device in a retail store, the activity data being received from one or more databases and relating to one or more employment activities performed by an individual in the retail store, the activity data including an indication of a status of completion of the one or more employment activities by the individual. The servers are also programmed to compute a performance metric associated with the individual by the electronic device, the performance metric being quantified based on predefined measures of a net value associated with a performance of the individual with respect to the one or more employment activities. The system also includes an electronic display device programmed to operate according to a first mode of operation to render a graphical user interface on an electronic display device via the electronic device, the graphical user interface including a decipherable graphical indication of the performance metric. The electronic display device is also programmed to receive, via a user-machine interface, identification information relating to the individual. The electronic display device is also programmed to operate according to a second mode of operation to update the graphical user interface, in response to the identification information, to display specific information relating to the individual. The electronic display device is also programmed to obfuscate a portion of the graphical user interface corresponding to the specific information relating to the individual to render the specific information undecipherable to others while allowing the individual accessing the graphical user interface decipher the specific information, wherein a remainder of the graphical user interface is decipherable by others.

In accordance with exemplary embodiments, a non-transitory computer readable medium storing instructions executable by a processing device is disclosed, wherein execution of the instructions causes the processing device to implement a method of controlling an electronic display device in response to instructions from a server via a communication network to render a graphical user interface on the electronic display device with portions of the display being obfuscated to protect private or confidential information associated with a user of the electronic display device and rendered in the graphical user interface. The method includes receiving, in an electronic computer-readable format, activity data by an electronic device in a retail store, the activity data being received from one or more databases and relating to one or more employment activities performed by an individual in the retail store, the activity data including an indication of a status of completion of the one or more employment activities by the individual. The method also includes computing a performance metric associated with the individual by the electronic device, the performance metric being quantified based on predefined measures of a net value associated with a performance of the individual with respect to the one or more employment activities. The method also includes operating the electronic device according to a first mode of operation to render a graphical user interface on an electronic display device via the electronic device, the graphical user interface including a decipherable graphical indication of the performance metric. The method also includes receiving, via a user-machine interface, identification information relating to the individual. The method also includes operating the electronic device according to a second mode of operation to update the graphical user interface, in response to the identification information, to display specific information relating to the individual. The method also includes obfuscating a portion of the graphical user interface corresponding to the specific information relating to the individual to render the specific information undecipherable to others while allowing the individual accessing the graphical user interface decipher the specific information, wherein a remainder of the graphical user interface is decipherable by others.

Any combination or permutation of the embodiments is envisioned. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of configuring a graphical user interface of an electronic display device, according to embodiments of the present disclosure.

FIG. 2 is a flowchart illustrating another exemplary method of configuring a graphical user interface of an electronic display device, according to embodiments of the present disclosure.

FIG. 3A depicts an exemplary electronic display device for rendering a graphical user interface in a first mode of operation, according to embodiments of the present disclosure.

FIGS. 3B-3D depict an exemplary electronic display device for rendering a graphical user interface in a second mode of operation, according to embodiments of the present disclosure.

FIG. 3E depicts an exemplary electronic display device for rendering a graphical user interface, according to embodiments of the present disclosure.

FIG. 4 is a diagram of an exemplary network environment suitable for a distributed implementation of exemplary embodiments of the present disclosure.

FIG. 5 is a block diagram of an exemplary computing device that can be used to perform exemplary processes in accordance with exemplary embodiments of the present disclosure.

### DETAILED DESCRIPTION

Following below are more detailed descriptions of various concepts related to, and embodiments of, inventive methods, apparatus, and systems for controlling an electronic display device to render a graphical user interface to facilitate displaying employee performance data with selective obfuscated portions. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein to facilitate controlling an electronic display device to facilitate selectively displaying or obfuscating employee performance data associated with one or more employees of an enterprise as well as personal and/or confidential employee data. According to exemplary embodiments, activity data associated with individuals (i.e. employees), such as tasks or activities completed along with the timing of completing those tasks by the individuals, is received by the system. The activity data is then stored at a database and used to compute performance metrics associated with the individuals, and these performance metrics may be displayed on an electronic display device as performance data via a graphical user interface. The graphical user interface rendered by the electronic display device can identify an individual's ranking with respect to the ranking of other coworkers based on the performance data, and can display one or more performance metrics that measure net value of the individual's tasks or activities (e.g., an economic value). For example, if the individual is a cashier working at a checkout station, the amount of sales and/or profits recorded by every item the cashier scans can be used to determine a real dollar amount corresponding to the activities performed by the individual and can be used to define an economic value of the individual to an operation of the store within which the individual works as well as to an operation of the enterprise as a whole. In another example, the dollar value of all the items placed on store shelves can be used to determine a dollar amount corresponding to the activities of a re-stocking associate.

As will be appreciated, the activity data used to compute the performance metrics disclosed herein may include, for example, numerical and/or statistical data corresponding to an individual's performance with respect to various work activities. As non-limiting examples, such activities can include one or more of the following: scanning items at a point of sale terminal, re-stocking items on a shelf, loading or unloading products into or from a storage area, returning carts from the parking lot to a store entrance, greeting customers as they enter a store, cleaning the floors or bathrooms, helping customers bring items to their vehicle, serving customers at a deli counter or pharmacy center, assisting a customer with finding a product, or any other activity performed by a worker within an enterprise. Individual activity data can be tracked, stored, and processed by the enterprise, and in some cases is tracked based on an individual's specific ID or login information. The activity data can be collected, for example, via a scanner or barcode reader associated with a point of sale terminal or a mobile scanner used by the individual. In another example, the activity data can be input to the system manually by the individual's manager or supervisor. A manager or supervisor may also input performance or career goals for individuals. The goals can be used in the computation of an individual's performance metrics, rankings, or achievements, and they may be set on a general or individual level. In exemplary embodiments, the number and/or type of achievements associated with an individual can depend on the individual's progress toward performance goals, which can be set by the individuals and/or their managers or supervisors.

Once this data is captured, it is processed by the system, and corresponding achievements or rankings of individuals for which the data is associated are updated on the electronic display device. The display device can update in real-time, or close to real-time, as tasks or activities are performed. The achievements and rankings of individuals can be rendered in a graphical user interface displayed by the electronic display device to make the awards and rankings publicly visible to employees at a store (e.g., the electronic display device can be disposed in a back/stock room) and can be accessible and viewable by employees. By publicly displaying the achievements and rankings, embodiments of the present disclosure can be used to recognize and reward positive performance of employees and encourage positive competition within a workplace. In exemplary embodiments, the electronic display device is incorporated within or connected to a kiosk or dashboard located in a back room of the enterprise. In some cases, an individual's activity can negatively impact their performance metric or ranking. For example, during peak shopping hours workers are encouraged to restock shelves rather than count the current items in a store. Accordingly, if an individual spends time counting items during peak shopping hours, or when the shelves are not properly re-stocked, that individual's performance metric or ranking may be reduced. This reduction may be updated in real time and displayed on the electronic display device. Additionally, because an individual's ranking and performance metric are visible for others to see, a coworker may question an awarded achievement or ranking if the coworker believes that an individual does not deserve a specific ranking or achievement. Inputting an audit request, via an associate terminal, can initiate an audit of one or more activities, performance metrics, or achievements associated with another coworker.

In exemplary embodiments, the electronic display device can be controlled to operate in two modes of operation. A first mode of operation, the electronic display device can be controlled to render the GUI to display a graphical indication of the performance metric of one or more individuals (i.e. employees) associated with a store, group of stores, and/or enterprise within which the individuals work. The performance metric can include, for example, an impact parameter associated with an individual, a performance ranking, a list of the highest performing associates within an enterprise with respect to certain activities, and the like. In exemplary embodiments, the first mode of operation can be a default mode of operation for the electronic display device, such as when nobody is interacting with the electronic display device (e.g., no employees are logged into the electronic display device). To initiate the second mode of operation, an individual can interact with a user-machine interface of the electronic display device to log into the electronic display device. In the second mode of operation, the individual that logged into the electronic display device can view a personalized graphical user interface that includes information specific to the individual (i.e. user-specific information). The user-machine interface can include, for example, an ID card reader or badge scanner (e.g., a magnetic reader, an optical reader, an RFID reader, and the like), which can scan or read a device specific to an employee in order to identify the employee logging onto the electronic display device. The user-specific information can include, for example, private or confidential information relating to the individual, such as Social Security Number, work schedule, date of birth, individual specific performance goals, individual specific incentives, etc. In the second mode of operation, all or a portion of graphical user interface rendered by the electronic display device may be obfuscated or filtered by a physical obfuscating structure embedded within, secured to, or affixed to a screen of the electronic display device. The obfuscation of the graphical user interface can be provided such that only the individual directly interacting with the display device may readily view the personal information displayed via the GUI (e.g., from certain viewing angles), while the obfuscation may prevent or reduce the likelihood that other individuals will be able to decipher the personal information (e.g., from certain viewing angles). In some embodiments, the obfuscation or filtering may be selectively activated or deactivated based on the content displayed via the GUI. In such an embodiment, the obfuscation or filtering is selectively deactivated during the first mode of operation and selectively activated to obfuscate all or a portion of a display screen during the second mode of operation. In some embodiments, specified portions of the screen of the electronic display device can be statically and/or permanently obfuscated and the electronic display device can be controlled to only render personal and/or confidential information within the obfuscated portions of the screen. In exemplary embodiments, the obfuscation may be implemented, for example, via a dynamically generated lenticular barrier, grid, or filter, static lenticular barrier, grid, or filter affixed or secured to the screen of the electronic display device or a portion of thereof, polarized filter covering all or a portion of the screen of the display device. In some embodiments, obfuscation of the screen may require the user of the electronic display device to utilize polarized glasses or lenses to enable the user to view and decipher specific content on the display device that has been obfuscated.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

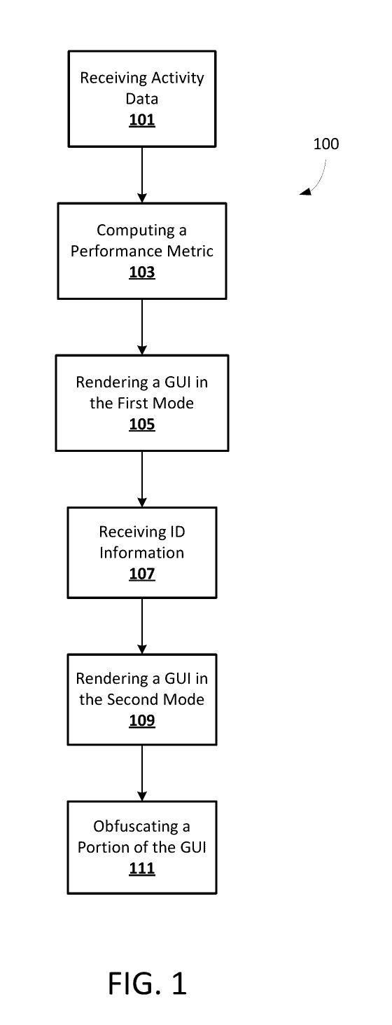

FIG. 1 is a flowchart illustrating an example method 100 for controlling an electronic display device in a retail store to render a graphical user interface with selectively obfuscated portions. In step 101, a server receives activity data, in an electronic computer-readable format, relating to one or more activities performed by individuals in the retail store. The activity data can include an indication of a status of completion of the one or more activities performed by the individuals. The activity data can include, for example, the number of scans performed per hour at a point-of-sale terminal, the number of items or cases stocked in a given time, the number of items or cases loaded or unloaded in a given time, the amount of time spent greeting customers entering a store, the number of bathrooms or aisles cleaned, etc. The activity data can be collected, for example, via a scanner or barcode reader associated with a point of sale terminal or a mobile scanner or reader used by the individuals. In another example, the activity data can be input manually by the individuals' managers or supervisors.

In step 103, performance metrics associated with each of the individuals is calculated. The performance metrics are quantified using metrics based on predefined measures of the net value of each individual's performance with respect to one or more activities. Activities may include, for example, scanning items at a point of sale terminal, re-stocking items on a shelf, unloading products into a storage area, etc. The performance metrics can include estimated monetary value reported as a result of the activities performed by the individuals. For example, if an individual is a cashier at a checkout station, the amount of sales and/or profits recorded by every item the cashier scans can be used to determine a real dollar value corresponding to the cashier's activities. In another example, the dollar value of all the items placed on store shelves can be used to determine a dollar value corresponding to the activities of a re-stocking associate. Additional activities, such as cleaning spills, can result in increased value to a store and therefore impact an individual's performance metrics. For example, increased floor cleanliness may increase sales on a particular aisle by a certain percentage. Thus, cleaning a spill in an aisle could lead to an increase in sales on that aisle corresponding to a certain dollar amount. The performance metrics can also include an increase in a customer satisfaction rating resulting from the activities performed by the individuals. For example, the enterprise may know, based on historical customer satisfaction surveys, that clean bathrooms and shopping aisles generally contribute to 20% of a shopper's customer satisfaction. Accordingly, when an individual cleans the bathrooms or cleans a spill in a shopping aisle, the performance metric associated with the individual can reflect a corresponding increase in customer satisfaction resulting from that particular activity. As described above, other enterprise activities, such as returning shopping carts to the front of the store, greeting customers as they enter a store, helping customers bring items to their vehicle, or helping a customer find a product can be used to determine a performance metric associated with an individual. The performance metric can also include a ranking of the individual's performance compared to other individuals working within a single store, a group of stores, and/or within the enterprise.

In step 105, the electronic display device is operated according to a first mode of operation to render a GUI on a screen of electronic display device to display graphical indication of the performance metrics associated with individuals working within a single store, a group of stores, and/or within the enterprise. The graphical indications can include, for example, graphical indications achievements earned by each of the employed individuals in response to performing one or more specific tasks by the employed individuals. The GUI can also update in real-time, or close to real-time, to indicate a modification of one or more of the graphical indications of the performance metrics. The graphical indications may be updated based on activity data indicating whether one or more activities or tasks have been completed by one or more of the employed individuals.

In step 107, identification information relating to the individual is received via a user-machine interface associated with the electronic display device. The user-machine interface can include, for example, a magnetic card reader, an RFID reader, a keyboard, a biometric scanner, or any other suitable input device for inputting identification information.

In step 109, the electronic display device is operated according to a second mode of operation to update the graphical user interface, in response to receiving the identification information in step 107. During the second mode of operation, the GUI may display specific information relating to the individual (i.e. user-specific information). The user-specific information can include, for example, private or confidential information relating to the individual, such as Social Security Number, work schedule, date of birth, individual specific performance goals, individual specific incentives, and/or any other private or confidential information.

In step 111, a portion of the graphical user interface corresponding to the specific information relating to the individual can be obfuscated, or filtered. In some embodiments, as described herein, only the individual directly interacting with the display device may be able to decipher the obfuscated or filtered personal information displayed via the GUI, while rendering the obfuscated or filtered personal information undecipherable to others. The remainder of the graphical user interface displaying general or public information can remain decipherable by others in the second mode of operation (i.e. the remainder of the GUI is not obfuscated or filtered). In some embodiments, the obfuscation or filtering may be electronically activated or deactivated based on the content displayed via the GUI. In such an embodiment, the obfuscation or filtering is deactivated during the first mode of operation and activated during the second mode to obfuscate all or a portion of a display screen to obfuscate at least the personal or confidential information. In some embodiments, the obfuscation may be implemented, for example, via a dynamically generated lenticular filter, grid, or barrier that can be controlled to selectively cover all or a portion of the display device, or dynamic screen filters that can be incorporated within a screen to display or partially obfuscate content depending on the content being displayed. In some embodiments, an obfuscating device can be statically and/or permanent disposed at portions of the screen of the electronic display device, and the electronic display device can be controlled to display the personal or confidential information at the obfuscated portions of the screen. For example, a lenticular filter, grid, or barrier can be embedded within the screen, affixed to the screen, or secured to the screen to obfuscate portions of the screen, and/or one or more screen filters can embedded within the screen, affixed to the screen, or secured to the screen to obfuscate personal or confidential information. In some embodiments, the user of the electronic device may be required to view the obfuscated portions of the screen using one or more devices, such as polarized glasses or lenses, which can allow the user to view polarized portions of the screen that would otherwise be obfuscated. When the user logs out of the electronic display device or a session times out, the electronic display device can return to the first mode of operation.

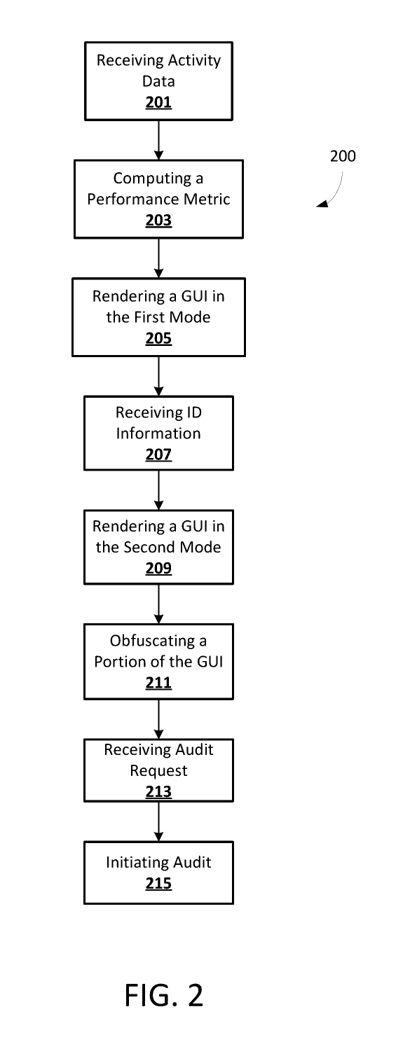

FIG. 2 is a flowchart illustrating another example method 200 for controlling an electronic display device to render a graphical user interface with selectively obfuscated portions, according to embodiments of the present disclosure. In step 201, a server receives activity data, in an electronic computer-readable format, relating to one or more activities performed by employed individuals in the retail store, a group of retail stores, or an enterprise. In step 203, performance metrics associated with each of the individuals is calculated. The performance metrics are quantified using metrics based on predefined measures of the net value of each individual's performance with respect to one or more activities. Activities may include, for example, scanning items at a point of sale terminal, re-stocking items on a shelf, unloading products into a storage area, etc. The performance metrics can include a real money value reported as a result of the activities performed by each individual, as described herein. The performance metrics can also include an increase in a customer satisfaction rating resulting from the activities performed by the individual, as described herein. The performance metric can also include a ranking of each of the individuals' performance compared to other individuals working within a single store, a group of stores or within the enterprise.

In step 205, the electronic display device is operated according to a first mode of operation to render a GUI on a screen of electronic display device to display graphical indication of the performance metrics associated with individuals working within a single store, a group of stores, and/or within the enterprise. The graphical indications can include, for example, graphical indications achievements earned by each of the employed individuals in response to performing one or more specific tasks by the employed individuals. The GUI can also update in real-time, or close to real-time, to indicate a modification of one or more of the graphical indications of the performance metrics. The graphical indications may be updated based on activity data indicating whether one or more activities or tasks have been completed by one or more of the employed individuals.

In step 207, identification information relating to the individual is received via a user-machine interface associated with the electronic display device. The user-machine interface can include, for example, a magnetic card reader, an RFID reader, a keyboard, a biometric scanner, or any other suitable input device for inputting identification information.

In step 209, the electronic display device is operated according to a second mode of operation to update the graphical user interface, in response to receiving the identification information in step 207. During the second mode of operation, the GUI may display specific information relating to the individual (i.e. user-specific information). The user-specific information can include, for example, private or confidential information relating to the individual, such as Social Security Number, work schedule, date of birth, individual specific performance goals, individual specific incentives, and/or any other private or confidential information.

In step 211, a portion of the graphical user interface corresponding to the specific information relating to the individual can be obfuscated, or filtered. In some embodiments, as described herein, only the individual directly interacting with the display device may be able to decipher the obfuscated or filtered personal information displayed via the GUI, while rendering the obfuscated or filtered personal information undecipherable to others. The remainder of the graphical user interface displaying general or public information can remain decipherable by others in the second mode of operation (i.e. the remainder of the GUI is not obfuscated or filtered). In some embodiments, the obfuscation or filtering may be electronically activated or deactivated based on the content displayed via the GUI. In such an embodiment, the obfuscation or filtering is deactivated during the first mode of operation and activated during the second mode to obfuscate all or a portion of a display screen to obfuscate at least the personal or confidential information. In some embodiments, the obfuscation may be implemented, for example, via a dynamically generated lenticular filter, grid, or barrier that can be controlled to selectively cover all or a portion of the display device, or dynamic screen filters that can be incorporated within a screen to display or partially obfuscate content depending on the content being displayed. In some embodiments, an obfuscating device can be statically and/or permanent disposed at portions of the screen of the electronic display device, and the electronic display device can be controlled to display the personal or confidential information at the obfuscated portions of the screen. For example, a lenticular filter, grid, or barrier can be embedded within the screen, affixed to the screen, or secured to the screen to obfuscate portions of the screen, and/or one or more screen filters can embedded within the screen, affixed to the screen, or secured to the screen to obfuscate personal or confidential information. In some embodiments, the user of the electronic device may be required to view the obfuscated portions of the screen using one or more devices, such as polarized glasses or lenses. When the user logs out of the electronic display device or a session times out, the electronic display device can return to the first mode of operation.

In step 213, an audit request is received requesting an audit of the status of completion of one or more activities. As discussed above, because the performance metrics are publicly visible, at least during the first mode of operation, an associate or coworker can initiate an audit in order to verify whether a specified individual deserves a specific performance metric, ranking, or achievement. Once the audit request is received in step 213, the audit is initiated in step 215. Once an audit is initiated, the system or an entity within the enterprise may act upon the audit and produce a confirmation of whether or not the work corresponding to the audit was accomplished. If the audit results are negative, the performance metrics associated with the individual and/or activities being audited can be updated accordingly. In some embodiments, if the same associate submits requests which rarely produce a negative result, audit requests by that associate may be disregarded.

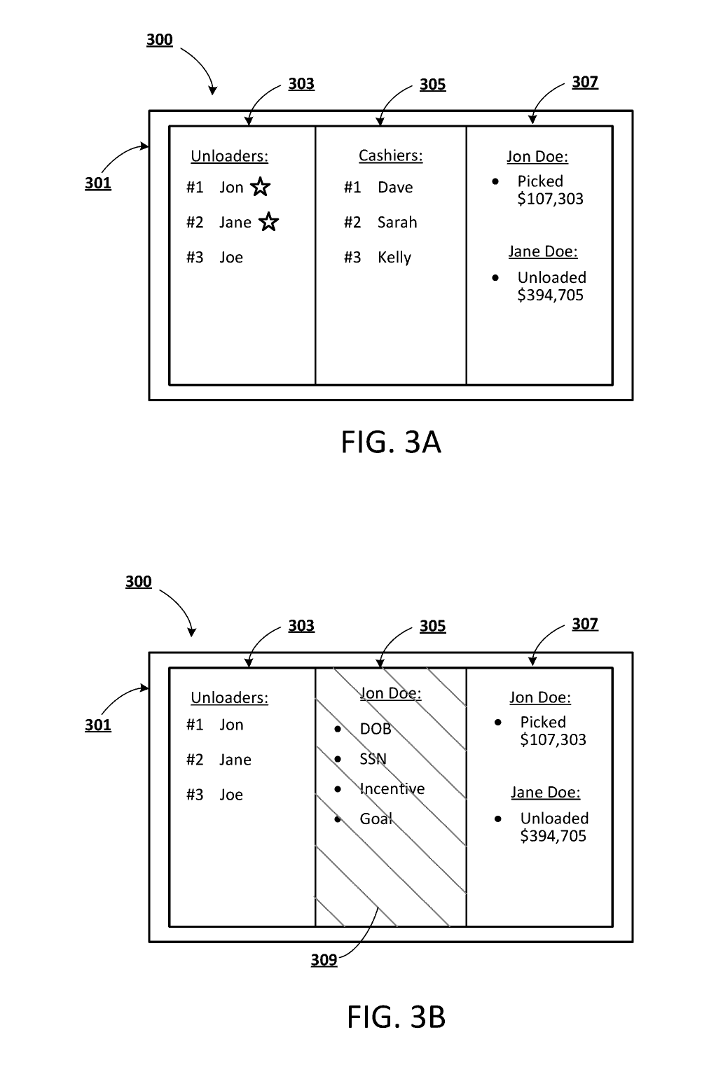

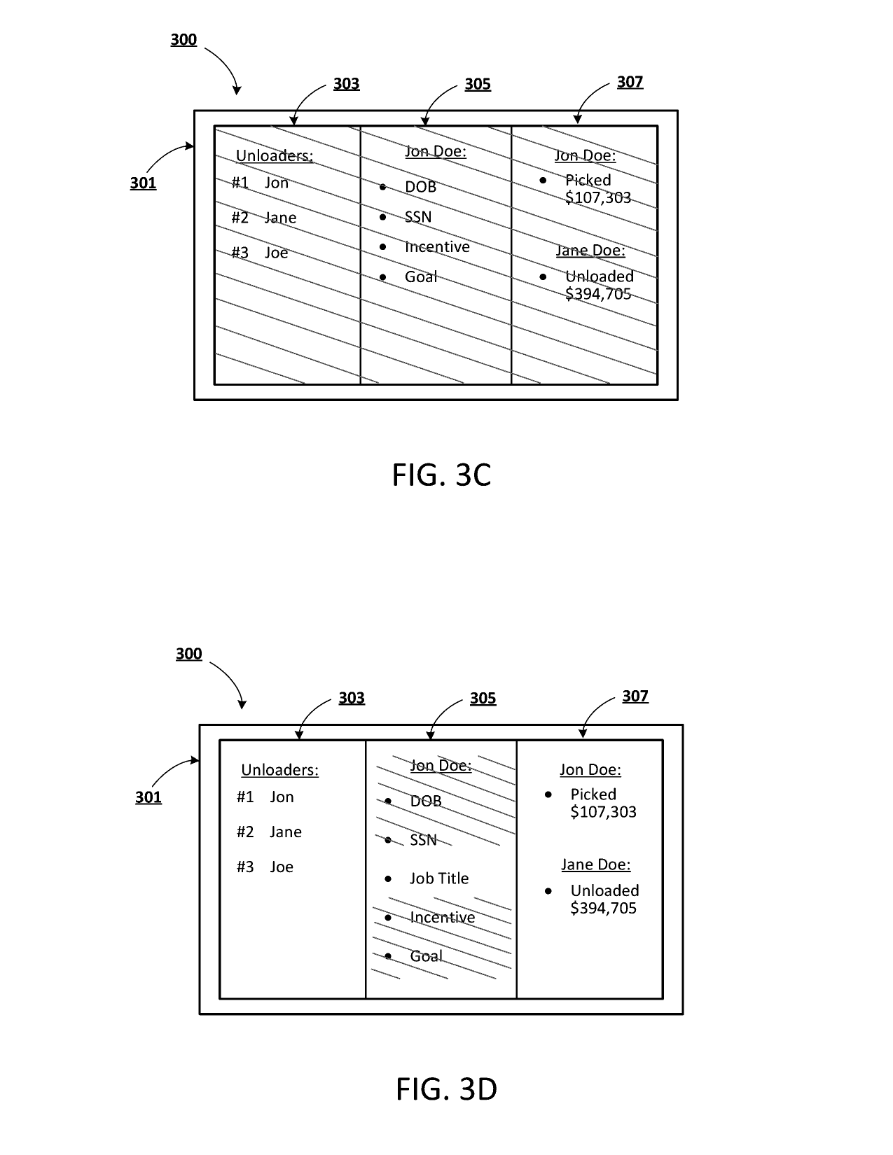

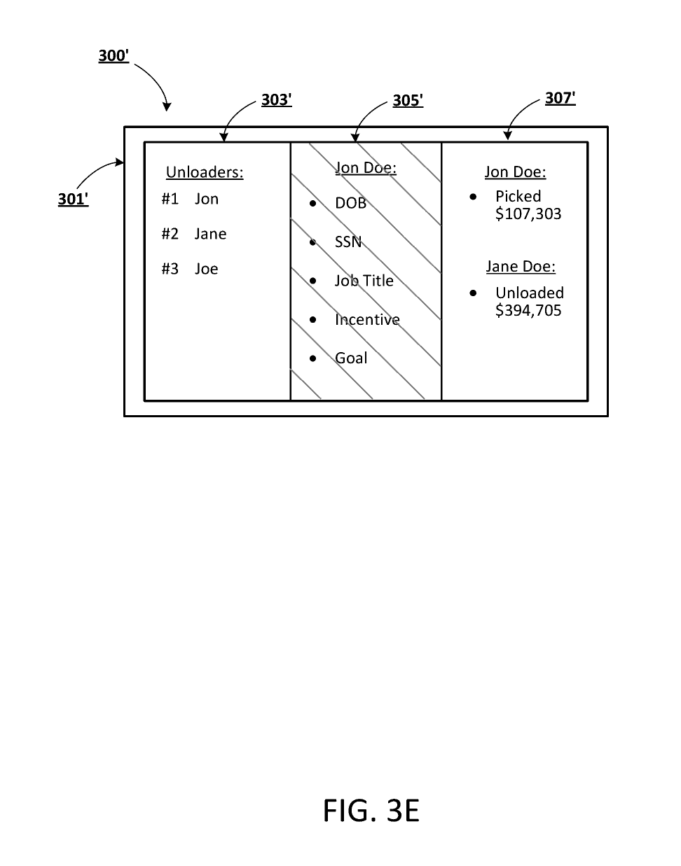

FIG. 3A depicts an exemplary electronic display device 300 corresponding to an operation of the electronic display device in a first mode of operation with an obfuscating device being deactivated, according to embodiments of the present disclosure. As shown in FIG. 3A, the electronic display device 300 renders and configures a graphical user interface 301 to display, on a screen of the electronic display device, various performance metrics and/or achievements in areas 303, 305, and 307 showing, for example, the highest performing individuals with respect to certain tasks and the dollar values associated with tasks performed by exemplary individuals. In exemplary embodiments, the area 303 includes a list of the top performing unloaders and any achievements associated with those individuals, the area 305 includes a list of the top performing cashiers, and the area 307 shows specific dollar values associated with the activities performed by two individuals. The top performing unloaders and/or cashiers may be computed, for example, based on the number of items unloaded or scanned within a given period of time. The achievements associated with individuals may include a star, as in this particular example, or any other graphical indication recognizing an individual for the performance of a task or completion of a goal. In this particular example, two associates have stars nearby their names, indicating that those associates have met a particular performance goal. As discussed above, the performance metrics can be updated and refreshed in real-time, or close to real-time, to reflect activities or tasks being performed by individuals within an enterprise.

FIG. 3B depicts an exemplary electronic display device 300 corresponding to an operation of the electronic display device in a second mode of operation with an obfuscating device being activated, according to embodiments of the present disclosure. As discussed above, once an individual's identification information has been received, for example via a magnetic card reader or badge scanner, the second mode of operation begins and user-specific information relating to the individual is displayed in area 305 of the GUI. In exemplary embodiments, the areas 303 and 307 can continue displaying the general information previously displayed in the first mode of operation, as described in reference to FIG. 3A. However, in the second mode of operation, the user-specific information relating to the individual is displayed in area 305, which is obfuscated or filtered by the obfuscating device 309 (e.g., a lenticular lens, grid, barrier, a polarizing filter) such that only the individual directly interacting with the display device may view the personal information displayed within area 305 (e.g., based on a viewing angle, the use of accompanying glasses, or otherwise). The user-specific information can include, for example, private or confidential information relating to the individual, such as Social Security Number, work schedule, date of birth, individual specific performance goals, individual specific incentives, etc. In some embodiments, the obfuscation or filtering of the obfuscating device 309 may be activated or deactivated based on the content displayed via the GUI. In such an embodiment, the obfuscation device is deactivated during the first mode of operation and activated to obfuscate area 305 during the second mode of operation. While FIG. 3B shows the obfuscation of the area 305 of the screen of the display device 300, embodiments of the present disclosure can be implemented such that the obfuscating device can selectively obfuscate the entire screen as shown in FIG. 3C, or only portions of the screen where the user-specific information is displayed, as shown in FIG. 3D (which may vary such that different portions of the screen can be obfuscated at different times depending where the user-specific data is displayed).

FIG. 3E shows another electronic display device 300′ corresponding to an operation of the electronic display device with an obfuscating device that statically and/or permanently obfuscates an area 305′ of the screen of the electronic display device 300′, according to embodiments of the present disclosure. As shown in FIG. 3E, in a first mode of operation, the electronic display device 300′ can be controlled to display, on a screen of the electronic display device 300′, a graphical user interface 301′ including various performance metrics in areas 303′ and 307′ showing, for example, the highest performing individuals with respect to certain tasks and the dollar values associated with tasks performed by exemplary individuals, while no information or data is displayed in the area 305′. When the electronic display device enters the second mode of operation (e.g., in response to a user logging into the electronic display device), the electronic display device can continue (or may cease) displaying the various performance metrics in the area 303′ and 307′, and can be controlled to display user-specific information in the obfuscated area 305′ (e.g., by controlling a rendering of the graphical user interface such that the user-specific information is output on the screen in the obfuscated area 305′.

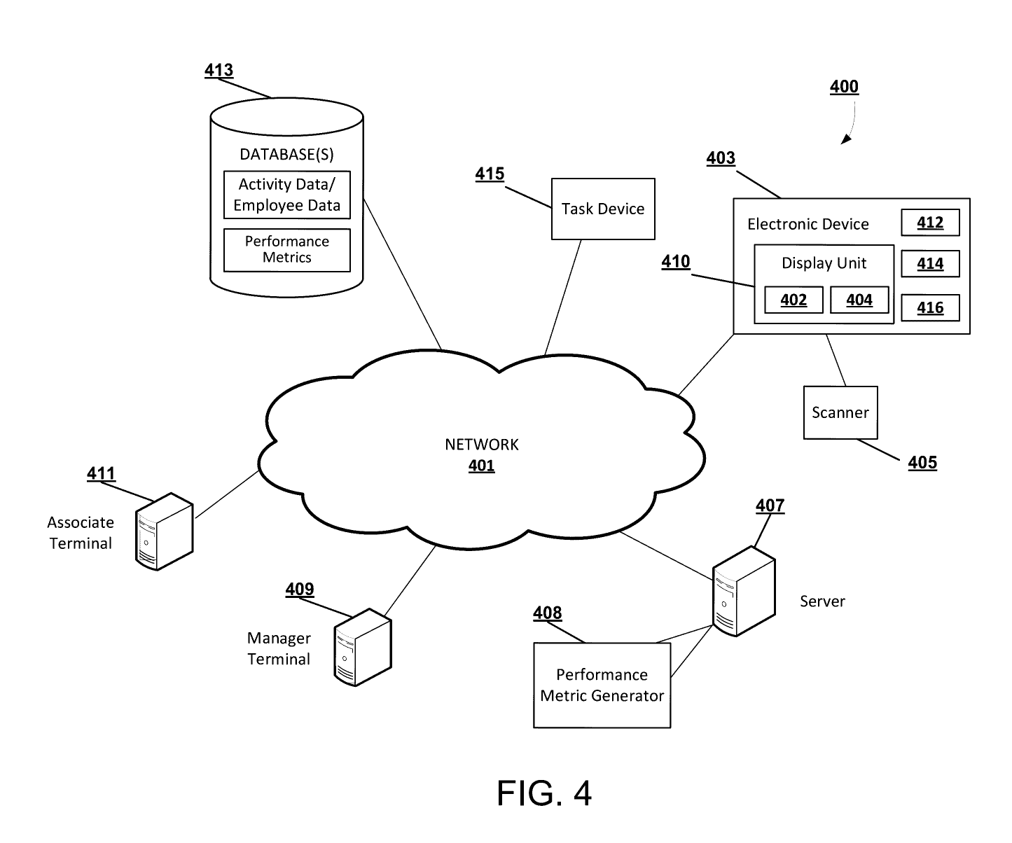

FIG. 4 is a diagram of an example network environment 400 suitable for a distributed implementation of example embodiments. The network environment 400 can include one or more servers 407 and a database 413, associated with server 407. In exemplary embodiments, the database 413 can store the various activity data, employee data, and/or performance metrics, while the server 407 can store a performance metric generator 408, which can implement one or more of the processes described herein with respect to FIGS. 1 and 2. The network environment may also include an electronic display device 403, that may be display GUIs 402 to a user as described above in reference to FIGS. 3A-3B. The electronic display device 403 can include a display unit 410 having an obfuscating device 404 embedded therein, affixed thereto, or secured thereon; a processing device 412; memory 414; and a network interface 416 where the processing device executes instructions in memory (e.g., in response to instructions from the server 407) to control an operation of the display unit as described herein. The electronic display device 403 may also include, or be in communication with, a scanner 405 such as a badge scanner or card reader that can receive identification information relating to an individual. Once the electronic device 403 receives instructions transmitted by the server 407 of the network 401 (e.g., via the network interface 416), the GUIs 402 may be rendered on the display unit 410 of the electronic device 403 (e.g., in response to execution of the instructions by the processing device 412) to allow a user of the electronic device 403 to interact with the server 407 to implement embodiments of the present disclosure. The network environment 400 can also include a task device 415, such as a scanning device that may be used by an individual when counting inventory or performing other tasks. The network environment 400 can also include a manager terminal 409, through which a manager or supervisor can interact with the server 407 and/or database 413 to input, access, and/or maintain activity data or performance goals for individuals. The network environment 400 can also include an associate terminal 411, through which an associate can interact with the server 407 and/or database 413 to initiate an audit request, as described above.

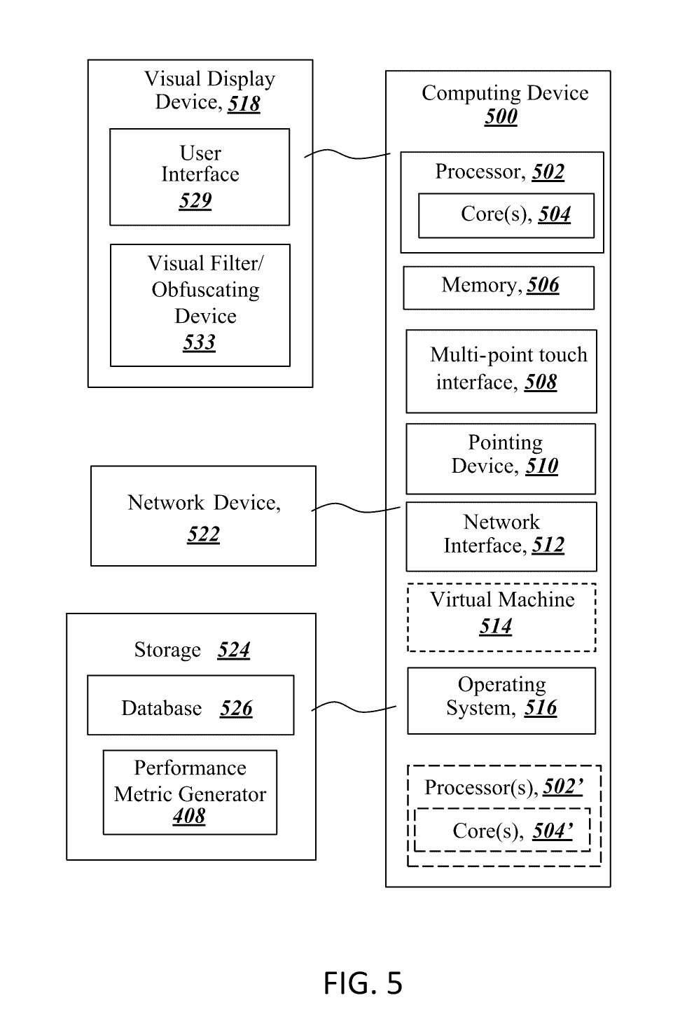

In exemplary embodiments, the server 407, manager terminal 409, associate terminal 411, database 413, task device 415, and the electronic device 403 may be in communication with each other via a communication network 401. The communication network 401 may include, but is not limited to, the Internet, an intranet, a LAN (Local Area Network), a WAN (Wide Area Network), a MAN (Metropolitan Area Network), a wireless network, an optical network, and the like. In exemplary embodiments, the electronic device 403 that is in communication with the server 407 and database 413 can generate and transmit a database query requesting information from the raw data matrices or database 413. As described above in reference to FIGS. 1-2, the server 407 can transmit instructions to the electronic device 403 over the communication network 401. The server 407 can interact with the electronic device 403 and database 413 over communication network 401 to render the GUIs, e.g., described in FIGS. 3A-3E on an operation of the electronic device 403, as described herein. Each of the server 407, performance metric generator 408, terminals 409 and 411, task device 415, and electronic device 403, can be implemented using one or more components described in reference to computing device 500 and visual display device 518, which are discussed in more detail below with respect to FIG. 5.

FIG. 5 is a block diagram of an exemplary computing device 500 that can be used in the performance of any of the example methods according to the principles described herein. The computing device 500 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like. For example, memory 506 included in the computing device 500 can store computer-readable and computer-executable instructions or software for implementing exemplary embodiments, such as a performance metric generator 408 programmed to perform processes described herein. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (504 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can be non-transitory computer-readable media including a computer system memory or random access memory, such as DRAM, SRAM, EDO RAM, and the like. Memory 506 can include other types of memory as well, or combinations thereof.

A user can interact with the computing device 500 through a visual display device 518, such as a touch screen display or computer monitor, which can display one or more user interfaces 529 that can be provided in accordance with exemplary embodiments, for example, the exemplary interface illustrated in FIGS. 3A-3B. The computing device 500 can include other I/O devices for receiving input from a user, for example, a keyboard or any suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals. The visual display device 518 can include a obfuscating/visual filter device 404, which as described herein may include a lenticular filter or polarized filter covering all or a portion of the display device, a screen capable of displaying information visible using polarized glasses or lenses, a dynamic screen filter that can be incorporated within a screen to display or selectively obfuscate content, or any other suitable filtering device.

The computing device 500 can also include one or more storage devices 524, such as a hard-drive, CD-ROM, or other non-transitory computer readable media, for storing data and computer-readable instructions and/or software, such as the performance metric generator 408, which may generate user interface 529 that implements exemplary embodiments of the methods and systems as taught herein, or portions thereof. Exemplary storage device 524 can also store one or more databases 526 for storing any suitable information required to implement exemplary embodiments. The databases can be updated by a user or automatically at any suitable time to add, delete or update one or more items in the databases. Exemplary storage device 524 can store one or more databases 526 for storing activity data, employee data, performance metrics, and any other data/information used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 516 can be run in native mode or emulated mode. In an exemplary embodiment, the operating system 516 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A method of controlling an electronic display device in response to instructions from a server via a communication network to render a graphical user interface on the electronic display device with portions of the display being obfuscated to protect private or confidential information associated with a user of the electronic display device and rendered in the graphical user interface, the method comprising:
receiving, in an electronic computer-readable format, activity data by an electronic device in a retail store, the activity data being received from one or more databases and relating to one or more employment activities performed by an individual in the retail store, the activity data including an indication of a status of completion of the one or more employment activities by the individual;
computing a performance metric associated with the individual by the electronic device, the performance metric being quantified based on predefined measures of a net value associated with a performance of the individual with respect to the one or more employment activities;
operating the electronic device according to a first mode of operation to render a graphical user interface on an electronic display device via the electronic device, the graphical user interface including a decipherable graphical indication of the performance metric;
receiving, via a user-machine interface, identification information relating to the individual;
operating the electronic device according to a second mode of operation to update the graphical user interface, in response to the identification information, to display specific information relating to the individual; and
obfuscating a portion of the graphical user interface corresponding to the specific information relating to the individual to render the specific information undecipherable to others while allowing the individual accessing the graphical user interface decipher the specific information, wherein a remainder of the graphical user interface is decipherable by others.

2. The method of claim 1, wherein the performance metric includes a real money value reported resulting from the one or more employment activities performed by the individual.

3. The method of claim 1, wherein the performance metric includes an increase in a customer satisfaction rating resulting from the one or more employment activities performed by the individual.

4. The method of claim 1, wherein receiving identification information includes receiving information from the individual via a magnetic strip reader, an RFID reader, a keyboard, or a biometric reader.

5. The method of claim 1, wherein the performance metric comprises a ranking of the individual's performance compared to other individuals working within a single store.

6. The method of claim 1, wherein performing a task at an improper time negatively effects the performance metric associated with the individual.

7. The method of claim 1, further comprising receiving, via the graphical user interface, an audit request initiated by a second individual requesting an audit of the status of completion of the one or more employment activities.

8. The method of claim 1, wherein the graphical user interface further comprises a graphical indication of an achievement earned by the individual in response to performing one or more specific tasks.

9. The method of claim 1, further comprising: updating the graphical user interface, in real-time, to indicate a modification of the decipherable graphical indication of the performance metric, based on the activity data indicating completion of the one or more employment activities.

10. A system for obfuscating private or confidential information associated with a user, the system comprising:
one or more servers programmed to:
receive, in an electronic computer-readable format, activity data by an electronic device in a retail store, the activity data being received from one or more databases and relating to one or more employment activities performed by an individual in the retail store, the activity data including an indication of a status of completion of the one or more employment activities by the individual; and
compute a performance metric associated with the individual by the electronic device, the performance metric being quantified based on predefined measures of a net value associated with a performance of the individual with respect to the one or more employment activities; and
an electronic display device programmed to:
operate according to a first mode of operation to render a graphical user interface on an electronic display device via the electronic device, the graphical user interface including a decipherable graphical indication of the performance metric;
receive, via a user-machine interface, identification information relating to the individual;
operate according to a second mode of operation to update the graphical user interface, in response to the identification information, to display specific information relating to the individual; and
obfuscate a portion of the graphical user interface corresponding to the specific information relating to the individual to render the specific information undecipherable to others while allowing the individual accessing the graphical user interface decipher the specific information, wherein a remainder of the graphical user interface is decipherable by others.

11. The system of claim 10, wherein the performance metric includes a real money value reported resulting from the one or more employment activities performed by the individual.

12. The system of claim 10, wherein the performance metric includes an increase in a customer satisfaction rating resulting from the one or more employment activities performed by the individual.

13. The system of claim 10, wherein receiving identification information includes receiving information from the individual via a magnetic strip reader, an RFID reader, a keyboard, or a biometric reader.

14. The system of claim 10, wherein the performance metric comprises a ranking of the individual's performance compared to other individuals working within a single store.

15. The system of claim 10, wherein performing a task at an improper time negatively effects the performance metric associated with the individual.

16. The system of claim 10, wherein the graphical user interface is further configured to receive an audit request initiated by a second individual requesting an audit of the status of completion of the one or more employment activities.

17. The system of claim 10, wherein the graphical user interface further comprises a graphical indication of an achievement earned by the individual in response to performing one or more specific tasks.

18. The system of claim 10, wherein the graphical user interface is further configured to update, in real-time, to indicate a modification of the decipherable graphical indication of the performance metric, based on the activity data indicating completion of the one or more employment activities.

19. A system for obfuscating private or confidential information associated with a user, the system comprising:
means for receiving, in an electronic computer-readable format, activity data from one or more databases relating to one or more employment activities performed by an individual in the retail store, the activity data including an indication of a status of completion of the one or more employment activities by the individual;
means for computing a performance metric associated with the individual by the electronic device, the performance metric being quantified based on predefined measures of a net value associated with a performance of the individual with respect to the one or more employment activities;
means for operating the electronic device according to a first mode of operation to render a graphical user interface on an electronic display device via the electronic device, the graphical user interface including a decipherable graphical indication of the performance metric;
means for receiving identification information relating to the individual;
means for operating the electronic device according to a second mode of operation to update the graphical user interface, in response to the identification information, to display specific information relating to the individual; and
means for obfuscating a portion of the graphical user interface corresponding to the specific information relating to the individual to render the specific information undecipherable to others while allowing the individual accessing the graphical user interface decipher the specific information, wherein a remainder of the graphical user interface is decipherable by others.
